(19) United States
(12) Patent Application Publication
(10) Pub. No.: US 2007/0232966 A1
(43) Pub. Date: Oct. 4, 2007

(54) Apparatus for skin and muscle treatment

(76) Inventors: Robert Applebaum, Los Angeles, CA (US); Alejandro Covalin, Edina, MN (US); Philip Klein, Los Angeles, CA (US)

Correspondence Address: PILLSBURY WINTHROP SHAW PITTMAN LLP, P.O BOX 10500, McLean, VA, 22102, US

(21) Appl. No.: 11/807,756

(22) Filed: May 30, 2007

Related U.S. Application Data
(63) Continuation-in-part of application No. 11/290,724, filed on Nov. 30, 2005.

(51) Int. Cl. A61H 15/02

(52) U.S. Cl. 601/17; 601/20

(57) ABSTRACT

A skin and muscle treatment apparatus and method employ one or more electrically-conductive rollers to deliver electrical current to, and thereby stimulate, the muscles underlying the skin. An onboard electrical circuit generates electrical current that is carried to one (or more) of the rollers through a conductive strip that is in electrical communication with the roller. Depending on the length of each roller and the pressure applied during use, the apparatus may also be used to provide a massaging effect. In addition, the apparatus may be used to deliver various ingredients, treatments, or medication to, into, or through the skin. The apparatus includes a main body portion, which may be tapered to serve as a handle, and an applicator or head portion that is configured to rotate with respect to the body portion. A resilient member, such as a spring, is provided to urge the applicator to its original position.

### CROSS-REFERENCE TO RELATED APPLICATION

This is a continuation-in-part of application Ser. No. 11/290,724, filed Nov. 30, 2005, the entire contents of which are incorporated herein by reference.

### FIELD OF THE INVENTION

The present invention is directed to systems and methods for providing electrical stimulation, massage, and treatments to the body and, in particular, to the delivery of electrical stimulation, massage, and treatments to the face, neck, and shoulder areas.

### BACKGROUND OF THE INVENTION

The effects of age and excess weight gain on the body are well known. Gravity, sunlight, and other factors cause the skin to sag and the muscles to weaken as the body ages. The accumulation of fat cells in the superficial layers of adipose tissue in combination with fibrous dermal attachments can result in unsightly bumps. These effects can be countered in part by massage, which causes a rearrangement of fatty deposits through external stimulation, and by exercise, which keeps the skin firm and tight and the underlying muscles strong. Massage and exercise not only lead to a much-desired youthful appearance, but also improve the general health and physical wellbeing. The benefits of massage and exercise are widely appreciated.

Muscles are commonly exercised by physical exertion. This has many well-known mental and physical benefits. For example, the release of endorphins associated with exercise and exertion is known to have a positive effect on the brain. However, physical exertion is not always a possible, convenient, or safe means of exercising the muscles. For instance, physical activity associated with exercise can lead to stress on the joints and bones. This is especially problematic for the overweight, whose bones are subjected to greater stresses. Similarly, the increased heart rate that accompanies physical exertion can be unhealthy for those with heart conditions or other impairments. Targeting and strengthening specific muscle groups that are not directly implicated in the movement of the limbs can also be difficult.

Muscles can also be exercised by electrical current stimulation, in much the same way the brain sends electrical stimuli to cause contraction of muscle cells. Electrical stimulation has the benefit of exercising muscles without requiring physical exertion, and has found application in particular in passive exercising and in the re-education of atrophied muscle tissue. Electrical stimulation allows specific muscle groups to be targeted and exercised, and can be a safer alternative for those with medical conditions that do not allow for vigorous physical exertion. Electrical current can also improve local skin circulation and assist with local lymphatic drainage.

One method of stimulating muscles with electrical current has been the application of patches containing electrodes to the skin. Because patches are affixed to the skin and are generally only a few square inches or less in area, they suffer from the disadvantage that only a localized surface area of the skin can be stimulated at any given time. In addition, in most cases, the use of such patches leads to a greater overall expense because the patches are disposable. As discussed in more detail below, such patches may also cause skin irritation.

Another way to firm the skin and muscles is through massage. Massage can stimulate muscle cells and redistribute the adipose tissue cells underlying the skin's surface. Rollers provide an ideal method of massage that can cover large surface areas with ease. Light pressure skin massage using rollers can also assist in the breakdown of skin surface irregularities. Massage with rollers thereby leads to smoother and more youthful-looking skin.

With specific regard to the face, it is well-known that aging skin loses elasticity as a result of decreasing elastin and the breakdown of collagen. In addition, facial animation leads to the deepening of facial lines which contribute to the aging effects on the facial skin. Moreover, environmental stress factors, such as sun exposure and pollution, also contribute to the aging of the facial skin.

As with the rest of the human body, aging effects on the face can be countered by the use of external massage combined with the application of electrical current onto the surface of the skin. The facial muscles are responsive to electrical stimulation with an effect of smoothing, toning the overlying skin, and wrinkle reduction.

However, while the results of facial muscle stimulation and external facial massage are widely appreciated, existing practice views electrical stimulation and massage as separate activities requiring separate periods of treatment and separate specialized equipment. As a result, individuals are generally required to invest greater amounts of time and money in order to enjoy the benefits of both electrical stimulation and massage. In addition, existing practice, in which small hand-held probes are used to provide electrical stimulation to multiple muscle groups, is also technically challenging, as the use of such probes requires a learned skill with accurate placement of probes across facial muscle groups.

There is therefore a need for a single device that is capable of delivering the therapeutic effects of both electrical stimulation and massage, as well as optional medicinal or other ingredients, to the face, neck, and shoulder areas.

### SUMMARY OF THE INVENTION

One object of the present invention is to combine the therapeutic effects of electrical stimulation and massage in a single device. Another object of the present invention is to effectively deliver electrical current concurrently with massage to the skin and the underlying muscles. Yet another object of the present invention is to deliver electrical current to a large surface area of the skin in a rolling and non-stationary fashion. An additional object of the present invention is to deliver electrical stimulation and massage to contoured areas of the human body, such as the face, neck, and shoulders, in a non-stationary fashion. Yet another object of the present invention is to deliver one or more medicinal or non-medicinal treatments to, into, or through the skin along with electrical stimulation and/or massage. Another object of the invention is to improve the appearance of the skin by providing for the tightening and firming of specific muscles. Other uses of the present invention may be apparent to one skilled in the art. It is noted that, in this application, the terms “user” and “subject” may be used interchangeably to refer either to the person delivering, and/or to the person receiving, the stimulation, massage, treatment, etc.

One embodiment of the present invention provides an apparatus for stimulating therapy which is comprised of one or more stimulating wheels, or rollers, arranged in parallel relationship with each other. The one or more rollers are moved and pressed onto a human skin and underlying tissues and rolled in the forward and backward directions, thereby applying the stimulation to the skin and underlying tissues. The stimulating wheels, or rollers, are electrically conductive and, as such, operate as electrodes. Thus, concurrently with the rolling motion, electrical current is delivered from the stimulating assembly to or into the skin and underlying tissues by means of one or more of the stimulating wheels/rollers. In this way, a superior stimulating effect can be achieved that combines the benefits of both massage and electrical stimulation.

The apparatus may be used with a conductive gel to more effectively deliver the electrical current to or into the skin. The conductive gel is applied to the skin in the areas of treatment and provides improved conductivity between the electrodes and the skin. The conductive gel may be water soluble and may have skin rejuvenating components with firming, toning, and wrinkle-reduction properties that improve the appearance of the skin. The gel may be wiped off the skin following the use of the device, leaving the skin with a clean and improved-looking appearance. Thus, the gel can be used as part of the treatment to augment the results obtained from the application of the apparatus.

In general, electrical stimulation devices can be characterized as bipolar or monopolar, though devices may also be multipolar. Whether a device is monopolar or bipolar will in part define its physical appearance and design. Both bipolar and monopolar devices have two electrodes. However, whereas, in bipolar devices, the electrodes are situated close together, in monopolar devices, a primary electrode delivers the electrical current at a delivery site and a secondary electrode may be situated anywhere else on the body. In one embodiment of the invention, the electrodes may be situated close together in a bipolar configuration, the wheels or rollers providing both electrodes. In alternative embodiments, a monopolar configuration may be employed, with one electrode providing the stimulation and the other electrode being applied to some other part of the body. In yet other embodiments, and especially in applications where better control of the spatial distribution of the electrical current is desired, a multipolar configuration may be utilized.

The present invention contains a number of benefits over the prior art. In contrast to the limited area of stimulation provided by patches, wheels or rollers can apply stimulation over a relatively wide surface area of the skin. In one embodiment, the device can roll over portions of the body having substantially large surface areas such as the back, legs, arms, or torso. In another embodiment, the apparatus may be small enough to roll over the surface contours of the face, neck, hands, shoulders, or other smaller areas of the body to stimulate localized skin surface areas that would be difficult or impossible to target with conventional electric current delivery methods. Thus, the present invention is adaptable to treat and stimulate variously-sized surface areas in the body. This effect is not limited to any localized area of the skin, but can be delivered to arbitrarily large surface areas without the need to reconfigure or adjust the mechanical or electrical components of the device.

In a specific embodiment adapted for application to the face and neck areas, the present invention may be contrasted from prior-art devices that have minimal contact electrodes with either two hand-held wands or closely approximated spherical dome leads. Thus, in one embodiment, the one or more wheels or rollers can apply stimulation over a relatively wide surface area of the skin by rolling over areas of the neck, jawline, and cheeks, for example, with sweeping movements effectively stimulating multiple facial muscle groups with a single pass. In this way, the one or more rollers efficiently and effectively tighten and firm the facial muscles while, at the same time, increasing local skin blood flow and improving underlying lymphatic drainage. Of course, the surface area that is covered in a single pass will depend on the length of the roller(s), and the massaging and stimulation effect that is delivered will depend on the pressure that is applied as the roller(s) travel along the area of application.

Another benefit of the present invention is the ability to operate at variable non-linear voltage or current levels. The strength of the electrical stimulation can be equated to the amount of electrical current delivered, which can be controlled either by varying the voltage or by varying the current. Delivery of electrical current to or into the skin is affected by the skin's resistance or impedance level, which may vary over time based on any number of factors such as the moisture content of the skin, temperature, skin type, pressure at which the message/stimulation is carried out, or duration and intensity of treatment. Varying the voltage or current can provide a more uniform treatment effect that compensates for changes in the impedance or resistance level of the skin over time and among different subjects.

In one embodiment of the invention, a knob or similar control means may be provided to vary the voltage level, thereby providing voltage-control. Voltage-control has the benefit of being less expensive to implement than current-control, and is suitable for non-critical applications such as the topical delivery of electrical current to or into the skin. In voltage-control embodiments, the current will automatically adjust depending on the actual impedance or resistance along the current path at any given time.

In other embodiments, it may be preferable to adjust the magnitude of the electrical current rather than voltage, and thereby provide current control. In the case of current control, the voltage will automatically adjust depending on the actual impedance or resistance along the current path at any given time. Current control may be preferable in some embodiments because it is the current, rather than the voltage, that provides the stimulating effect on the skin and muscles. Thus, controlling the current level provides for an accurate and precise means of delivering the stimulation and accounting for fluctuations in factors such as skin impedance or resistance. This is especially important when providing stimulation to sensitive organs or muscles within the body.

In traditional electrical stimulation devices, current and voltage adjust automatically according to the well-known Ohm's law, expressed as V=IR. As this law suggests, there is a linear relationship between voltage and current in traditional devices. That is, as voltage increases, current increases in proportion to the electrical resistance or impedance along the current path. The present invention is unique compared to traditional devices in providing at least a partial non-linear electrical flow whereby the current and voltage are capped at certain preset levels. This non-linear relationship is embodied in the internal electronics of the device, thereby providing greater safety in the occasion of a short-circuit or malfunction; that is, because the relationship is partially or wholly non-linear, a sudden decrease in resistance will not cause a spike in voltage or current. This protects the subject against injury and prevents damage to the internal circuit components.

Because the electrical current or voltage is variable, it is possible to select a suitable electrical current to apply optimum stimulation, depending upon the particular needs and comfort level of the subject and the muscle group to be stimulated. The current or voltage delivery is adjustable with, e.g., a simple turn dial on the device. Thus, the current or voltage level may be selected or set from a range of available currents and voltages.

In one embodiment, the present invention may provide an additional advantage by including a knobbed surface configuration for one or more of the wheels/rollers. The skin has a normal layer of dry surface cells that protects the skin, but lowers conductivity and increases the skin's resistance or impedance. A knobbed surface is better able to conduct electricity through this layer of dry skin cells to the more conductive skin cells underneath. When used in combination with the conductive gel, conductivity may be increased even further by providing better contact with the underlying skin cells. By improving conductivity, the same stimulating effect can be achieved with lower voltage levels, providing for a smaller, simpler, more efficient, and safer device.

Another advantage of the present invention is that monophasic current may be used to stimulate the skin. Monophasic current has the advantage of requiring less current to obtain the desired stimulation effect. Thus, devices using monophasic current can be powered for a longer period of time by compact portable batteries and therefore be manufactured to have smaller dimensions and lower weight. Monophasic current can also be created using less expensive and simpler components, which lowers the cost of the device by lowering the cost of its component parts and simplifying the manufacturing process. In other embodiments, biphasic current may be used.

The present invention has both cosmetic and medical applications. In a cosmetic application, the rolling action of the wheels/rollers provides a direct topical skin massage that, when combined with electrical stimulation, is effective to improve the appearance of the skin and its surface irregularities.

Embodiments of the invention may also be used in a medical application. Generally speaking, surface skin irregularities can be caused by the accumulation of fat cells and the presence of excessive subcutaneous fibrous dermal-fat attachment bands. For example, a primary reason for surface skin irregularities is the dimpling effect caused by accumulation of fat cells between the dermis and underlying connective tissue, primarily in the hips-thighs-buttocks region of the human body. Skin irregularities and the “orange peel” appearance of skin are due to organization of fat cells and the presence of connective fibrous bands connecting dermis to underlying fat.

In one aspect of the medical application, the present invention improves the appearance of the skin by improving superficial skin blood circulation. Greater blood flow corresponds to greater oxygen delivery to the site, leading to healthier looking skin. Combining massage and electrical stimulation in one effective treatment improves the appearance of skin and selectively improves muscle tone in the areas of use.

In another aspect of the medical application, the present invention relates to facilitating ionic transfer to or into the skin by monophasic current. Electricity interacts with the skin in a well-known electrochemical process by increasing or decreasing the flow of ions through the skin. Monophasic current operates to increase the flow of ions in one direction only, that is, either “pulling” ions away from the skin or “pushing” ions towards the skin. Biphasic current operates to cause ion flow in both directions by alternating between “pulling” and “pushing.”

In another aspect of the medical application, the present invention can be used with either monophasic or biphasic current. In one embodiment, monophasic current is used to facilitate ionic transfer to or into the skin (i.e., iontophoresis). In most existing electrical stimulation devices, monophasic current is not used due to a higher risk of skin irritation. However, when, as in the instant invention, the electrodes are not stationary, the risk of skin irritation is substantially reduced because the current is not being sustained to a particular patch of skin.

In yet another aspect of the medical application, the present invention may be used as an adjunct for delivery of the gel's active ingredients to or into the skin by iontophoresis. The gel may be configured to contain a solution of charged (ionized) particles. When used in conjunction with monophasic current provided by the device's electrodes, the electric field will “push” the charged particles to or into the skin, thereby creating a means for delivering ingredients to or into the skin by iontophoresis.

For example, in a simple salt water solution, polar water molecules divide the salt molecule into positively-charged sodium ions (Na⁺) and negatively-charged chloride ions (Cl⁻). Depending on the direction of electrical current, monophasic electric current can be applied to drive either the sodium or chloride ions into the skin. Using this technique (i.e., iontophoresis), it is possible to drive many ionic gel solvents into the skin.

In yet other embodiments, the apparatus of the present invention may be used to deliver a treatment to the subject's skin, tissue, and/or muscles. For example, the apparatus of the present invention may be used to deliver ingredients from over-the-counter formulas for the treatment of acne, psoriasis, and other topical dermatologic conditions. Additional examples of treatments that may be delivered through the use of the instant invention may include topical ointments, muscle relaxants, pain relievers, and other such topical applications.

In an additional embodiment of the present invention, the electrodes may vibrate to provide further stimulation to the skin and underlying tissues. Moreover, by means of the gate-control theory of pain, vibration can also provide a local numbing effect, which translates into a higher level of tolerance for the electrical stimulation. Vibration may be provided by means of pads or other non-rolling electrodes. The electrodes may be contained on a single vibrating pad, or may be contained on separate pads.

### BRIEF DESCRIPTION OF THE DRAWINGS

FIG. 1 is a perspective view of an apparatus in accordance with an embodiment of the present invention;

FIG. 2 is a left side view of the apparatus shown FIG. 1;

FIG. 3 is a right side view of the apparatus shown FIG. 1;

FIG. 4 is a bottom view of the apparatus shown FIG. 1;

FIG. 5 is a perspective view of an apparatus in accordance with an alternative embodiment of the present invention;

FIG. 6 is a left side view of the apparatus shown in FIG. 5;

FIG. 7 is a bottom view of the apparatus shown in FIG. 5;

FIG. 8 is a perspective view of the interior of a head portion of the apparatus shown in FIG. 5;

FIG. 9 is a cutaway bottom view of the apparatus shown in FIG. 5;

FIG. 10 is a cutaway perspective view of the apparatus shown in FIG. 5;

FIG. 11 is a cutaway left side view of the apparatus shown in FIG. 5; and

FIG. 12 shows a high-level schematic of the electronics employed in an embodiment of the present invention.

### DETAILED DESCRIPTION

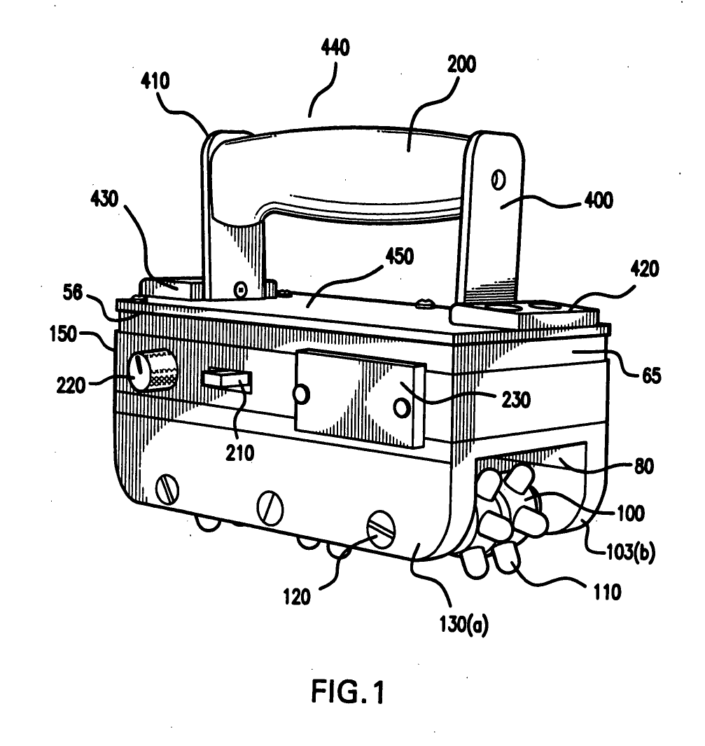

A perspective view of one embodiment of the device or apparatus of the present invention is shown in FIG. 1. As shown in FIG. 1, the apparatus has a generally rectangular housing 150 with an upper surface 450, two longer sides 55 (not shown) and 60 comprising the longer sides of the rectangular housing, and two shorter sides 65 and 70 (not shown) at the front and back comprising the shorter sides of the rectangular housing. Secured to the upper surface 450 is a handle assembly 440 capable of holding the device securely when in use or when being transported. The handle assembly extends along the longer sides of the housing to provide leverage when the device is put into motion in a longitudinal direction. The handle assembly is comprised of a grip 200, a first support 410, a second support 400, and fastening plates 420 and 430.

The grip 200 may be composed of a cushioning material to absorb shocks caused by the rolling motion of the device as it is used over the contours of the body, and to provide for comfort when in use. Fastening means secure the grip in place by coupling its longitudinal ends to the first support 410 and the second support 400. The first and second supports extend in a downward direction from the grip towards the upper surface 450 such that together with the grip, they form an inverted u-shape to allow the user's fingers to comfortably and securely wrap around the grip. Fastening plates 420 and 430 are coupled, on the one hand, to the upper surface 450, and on the other, to the first and second supports by screws or other fastening means.

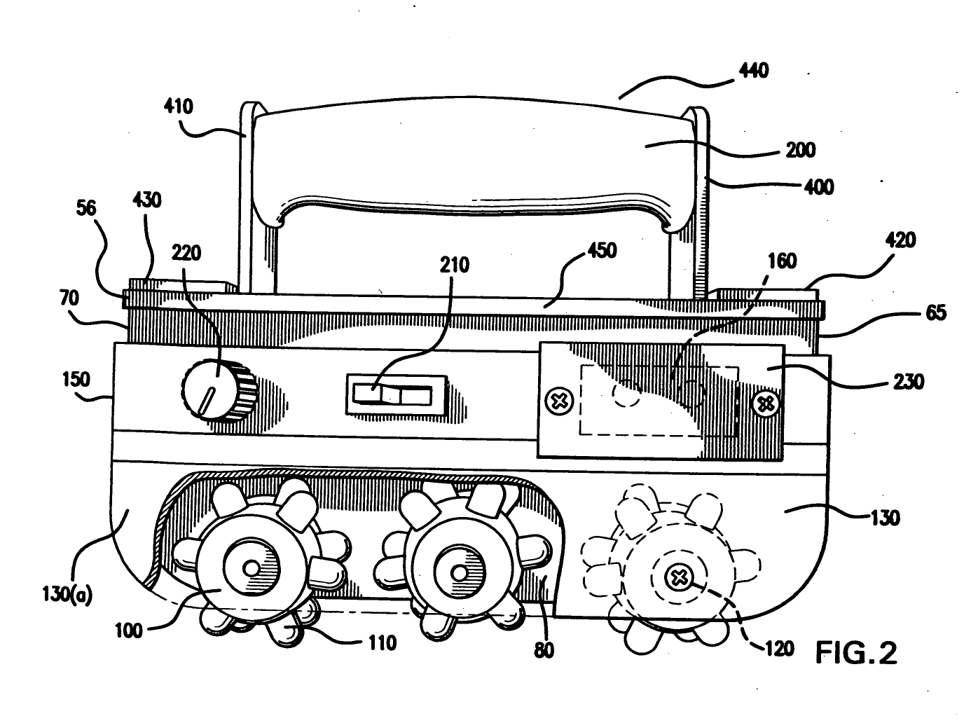

As shown in the diagrams, each of the longer sides 55, 60 is generally vertically disposed, such that an upper edge 56, 61 of the longer sides 55, 60, respectively, is disposed adjacent the upper surface 450. Each of the longer sides 55, 60 includes a lower portion 130a, 130b, respectively. The lower portions 130a and 130b, in turn, define therebetween an internal cavity 80. The corners of the lower portions may be curved in order to be blunt rather than sharp, so as to provide comfort and safety when in use. Situated in the cavity 80 are a plurality of wheels 100 and axles 120. Each axle has one or more wheels joined thereto in a rotatable configuration. Portions of each wheel extend beyond the lower portions 130a, 130b such that the wheels may contact a surface without substantial physical interference from the lower portions. The internal cavity 80 is of sufficient depth to allow the wheels to rotate about the axles without substantial physical interference. Provided on the external surface of the rectangular housing are a dial 220, a power switch 210, and a battery cover 230 which are described in more detail below with reference to FIG. 2.

A left side view of the device with a cutaway view of the wheels is shown in FIG. 2. A power switch 210 is used to turn the electrical current on and off, and a dial 220 allows the electrical current or voltage to be varied. In the embodiment depicted in the figures, the electrical current is to provide stimulation to the muscles, however in other embodiments it may have the additional function of providing power to drive the wheels. The electrical current may be supplied by batteries 160, which may be held within an upper portion of the device by a removable battery cover 230.

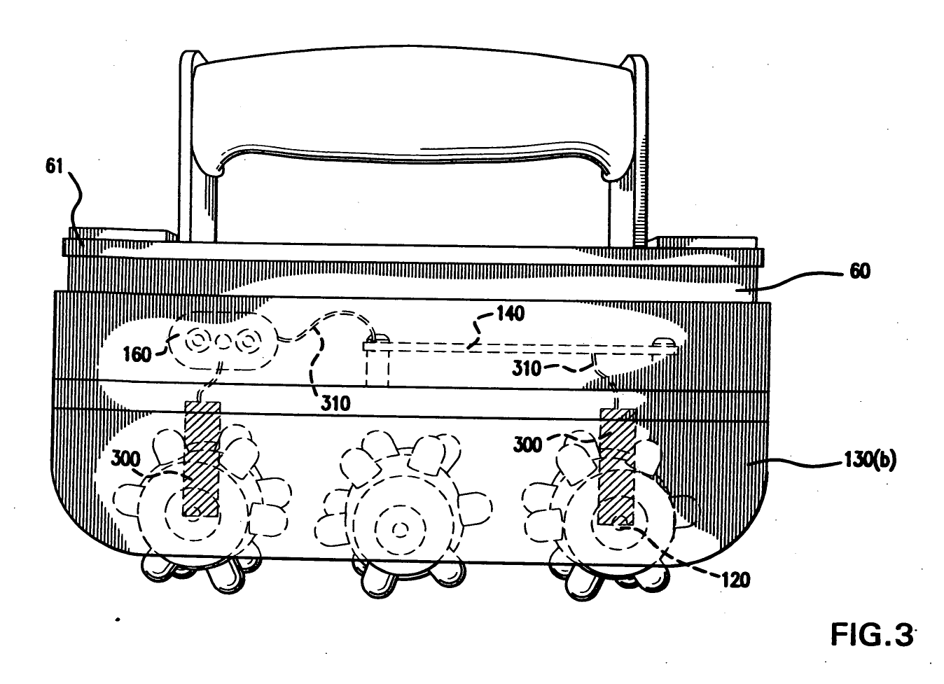

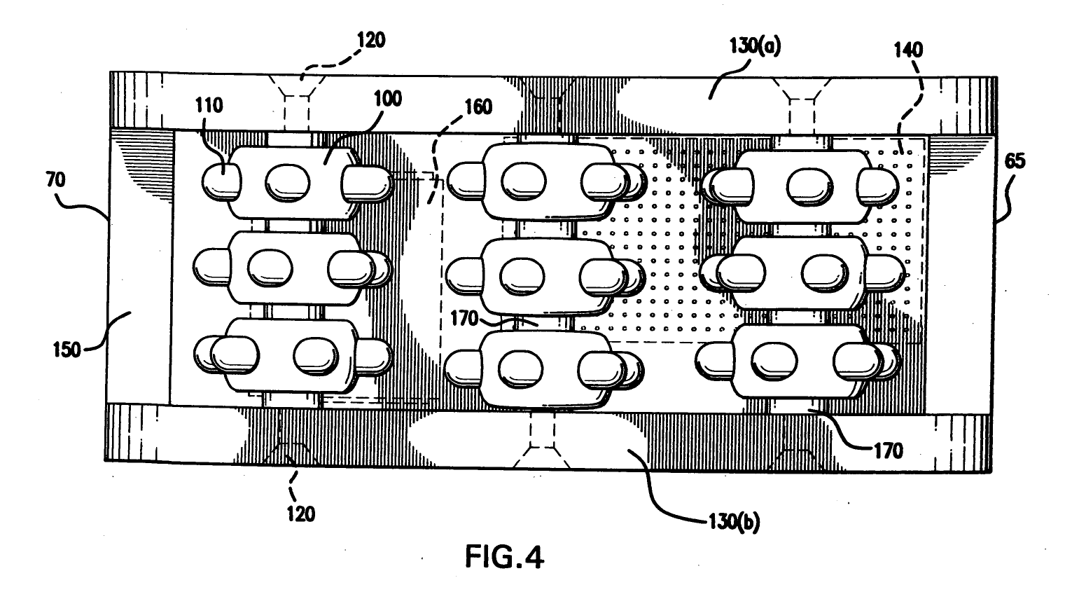

FIG. 3 shows a right side view of the device with the batteries 160, circuit board 140, and conductive strips 300 shown in phantom and connected together via wires 310. A spacer 170 is positioned between each wheel (see FIG. 4), and between the wheel and the lower portion 130a or 130b. The conductive strips conduct electrical current to the axles 120 through contact with the spacers 170, which, in turn, conduct the electrical current to the wheels 100, thereby forming an electric circuit. Electrical current is conducted between the conductive strips 300 and the wheels by means of physical contact between the conductive strips 300, spacers 170, and the wheels 100. In particular, as shown in FIG. 3, the wires conduct electrical current between the batteries 160 and the circuit board 140, the batteries 160 and one conductive strip 300, and between the circuit board 140 and another conductive strip 300. The conductive strips, in turn, conduct electrical current to the spacers 170 by means of physical contact with the spacers. Depending on the friction between the spacers and the wheels, the spacers may or may not rotate about the axles as each wheel is turned.

The conductive strips thereby provide conductivity between the moving parts of the device, which include the wheels, and the non-moving parts of the device, which include the balance of the device's component parts, including the axles and the circuit board. As shown in FIG. 3, the device may contain three axles with wheels, but the two endmost axles with wheels are provided with electrical current. This allows a circuit to be formed between the two endmost axles. In this arrangement, it is important that the material composition of the wheels, axles, and other parts of the circuit to which electricity is provided is conductive in nature. For example, the wheels may be made in part of steel (e.g., stainless steel) or aluminum, but not wholly of a non-conductive plastic or ceramic. Moreover, the composition of the wheel need not be uniform, and may have both non-conductive parts and conductive parts, as long as conductive portions come into contact with the skin and with the axle. For the middle axle and set of wheels, since no electrical current is being provided, the conductivity of the material composition is not important. Therefore, these components may be made of any material without regard to conductivity. It is noted that, in alternative embodiments, any number of the existing axles with wheels might be provided with electrical current.

With reference to the bottom view shown in FIG. 4, the massage device contains a housing 150 having lower portions 130a and 130b that support the axles 120. Wheels 100 are pivotally mounted on the axles such that the wheels may rotate freely. Wheels 100 are separated by spacers 170 that hold the wheels apart and secure them from moving laterally along the length of the axles.

The wheels may have knobs 110 for massaging the skin. When provided, knobs 110 have the benefits described above, including the ability to penetrate the dry layers of skin to better conduct electricity, the exertion of greater pinpoint pressure to massage and stimulate the muscles, breaking down surface irregularities, and improving the appearance of the skin.

In other embodiments, however, knobs may not be present. For example, in smaller devices that target the face, knobs could impede free rotation of smaller-diameter wheels. In other embodiments, a smooth and flat rolling surface may be desirable for comfort or other reasons, such as where conductivity and high pressure massage are less of a concern.

In yet other embodiments, the wheels 100 may be driven by a motor such that the movement of the wheels causes the entire device to be self-propelled in forward or backward directions across the body. Thus, the device may be put into use with less effort as it does not require external force to be put into motion. Driving of the wheels may be accomplished by means of a belt, chain, wheel and pulley system, or by any other means apparent to one skilled in the art. Engagement of the drive mechanism can be provided by a switch, knob, or other input mechanism, and may further provide for switching between driving in the forward or backwards directions. Knobs on the wheels may have further use in this embodiment by providing traction in much the same way knobbed treads on tires may provide traction to the driven wheels of a motor vehicle.

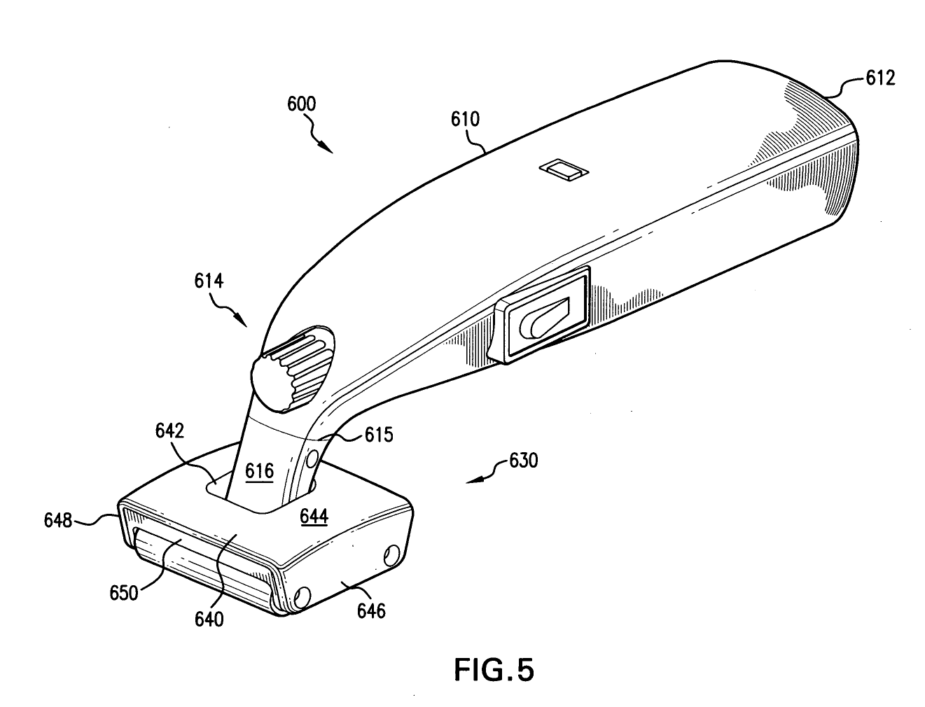

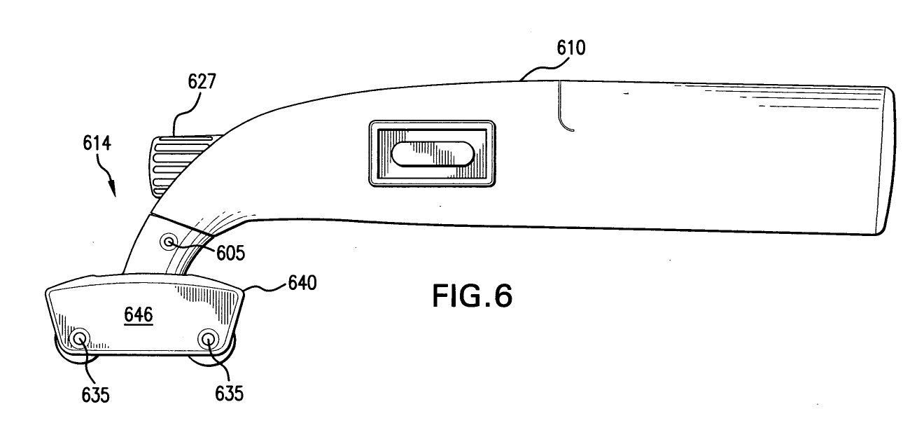

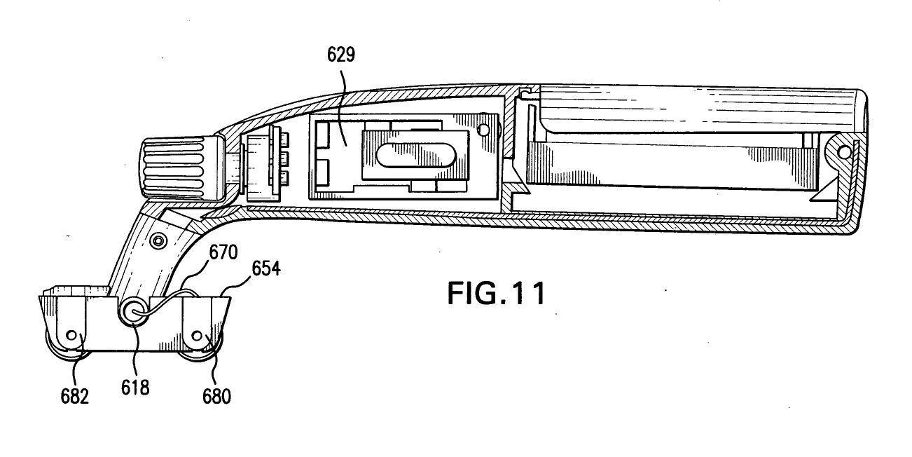

As shown in FIGS. 5-11, in an alternative embodiment, a skin and muscle treatment apparatus 600 includes a main body 610 having a rear section 612 and a forward section 614. The forward section 614 is generally angled with respect to the main body 610 such that, when the apparatus 600 is held horizontally, the forward section 614 angles downwards with respect to the longitudinal axis of the main body 610 (see FIG. 6). In embodiments of the invention, the main body 610 is tapered along its longitudinal axis between the rear section 612 and the forward section 614 and may constitute a handle portion to enable a user to grip the apparatus 600.

In a preferred embodiment, the forward section 614 comprises an extension arm 616 having an attachment end 615 and an opposing free end 617. The extension arm 616 is coupled to the main body 610 by one or more screws, bolts, or other attachment means 605 proximate its attachment end 615. Proximate its free end 617, the extension arm 616 includes a transverse cylindrical member 618 that is unitary with the extension arm 616 and is disposed such that its longitudinal axis is substantially perpendicular to the longitudinal axis of the main body 610. In the preferred embodiment, the cylindrical member 618 is hollow and has a circular cross-sectional geometry.

As shown in the diagrams, the forward section 614 is coupled to a head portion (or applicator) 630 having an upper casing 640 and a lower casing 650. The upper casing 640 is generally in the shape of an inverted “U”, with a top surface 644 defining the generally horizontal portion of the “U” and the two opposing side walls 646, 648 that depend vertically downwards from the top surface 644 defining the generally vertical portions of the “U”. On its top surface, the upper casing 640 also includes a central opening 642 that is large enough to accommodate the extension arm 616 or, more generally, at least a portion of the forward section 614.

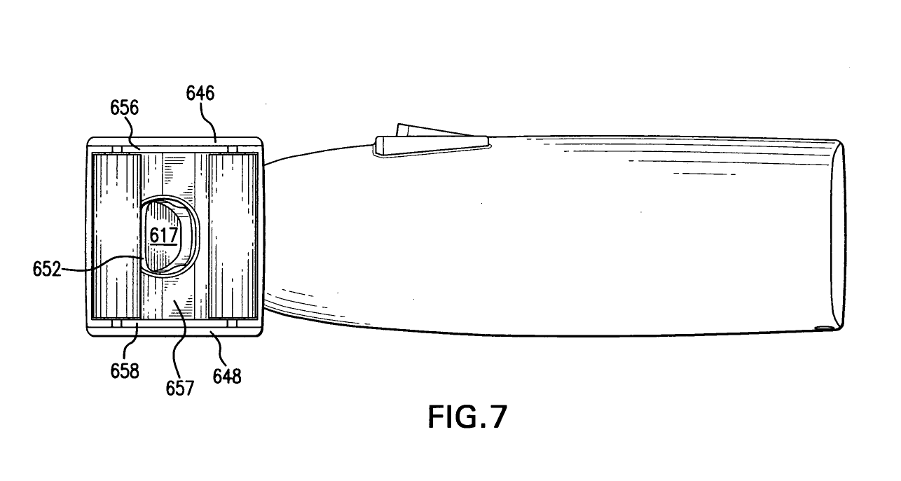

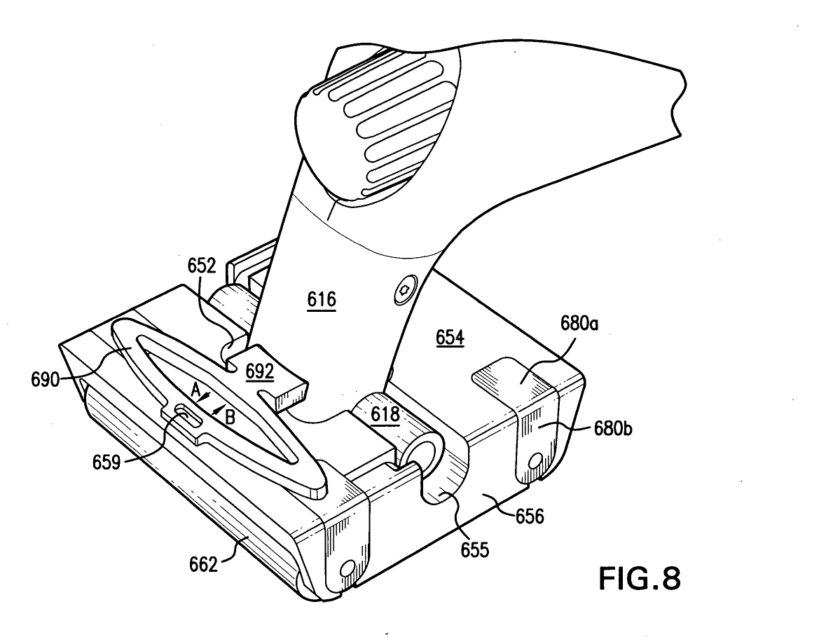

The lower casing 650 lies underneath the upper casing 640 and is also generally in the shape of an inverted “U”, with top surface 654 defining the generally horizontal portion of the “U”, and the two opposing side walls 656, 658 that depend vertically downwards from the top surface 654 defining the generally vertical portions of the “U”. As shown in FIGS. 7 and 8, the lower casing 650 also defines a channel 655 through a central axis thereof which acts as a receptacle for matingly receiving the transverse cylindrical member 618. As such, in the preferred embodiment, the channel 655 has a semi-circular, or semi-elliptical, cross-sectional geometry and runs to, and through, the side walls 656, 658.

In addition, the lower casing 650 includes a central opening 652 that runs through a bottom surface 657 of the channel 655 and coincides, generally, with central opening 642 of the upper casing 640. Thus, when assembled, the transverse cylindrical member 618 rotatably rests within the channel 655, and the free end 617 of the extension arm 616 is accommodated within the openings 642, 652. It is noted that, in alternative embodiments, the channel 655 may run through an off-center section of the lower casing 650, and/or may be shorter than the entire distance between the side walls 656, 658. In this case, the transverse cylindrical member 618 would also be sized accordingly so as to mate with, and be received in, the channel 655.

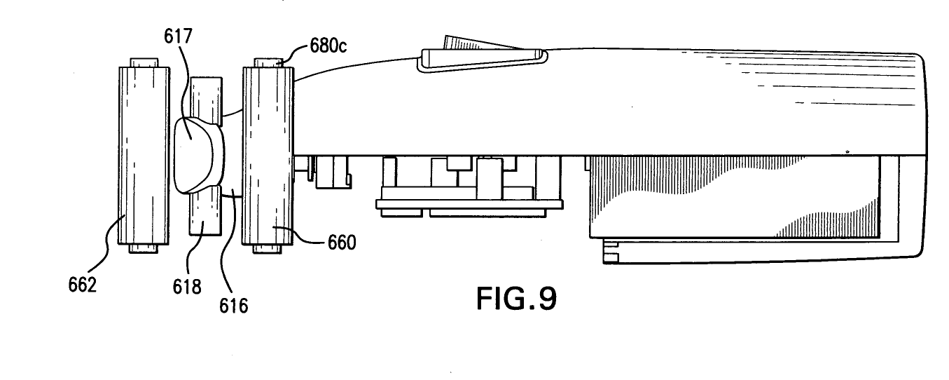

FIGS. 9-11 show a pair of elongated, electrically-conductive rollers 660, 662 that are rotatably held within, i.e., operationally coupled to, the lower casing 650 and are configured to rotate upon a subject's skin during use of the apparatus 600. As with the other embodiments described above, the rollers 660, 662 are intended to both massage the subject's muscles as they roll upon his/her skin and, at the same time, provide electrical stimulation to the subject's muscles. In the instant embodiment, the latter may be accomplished by means of electrical current that is generated via an electrical circuit within the main body 610 of the apparatus and carried by means of a wire, cable, or other electrical conductor 670, 672 to one or more of the rollers 660, 662 through one or more conductive strips 680, 682, 684, 686.

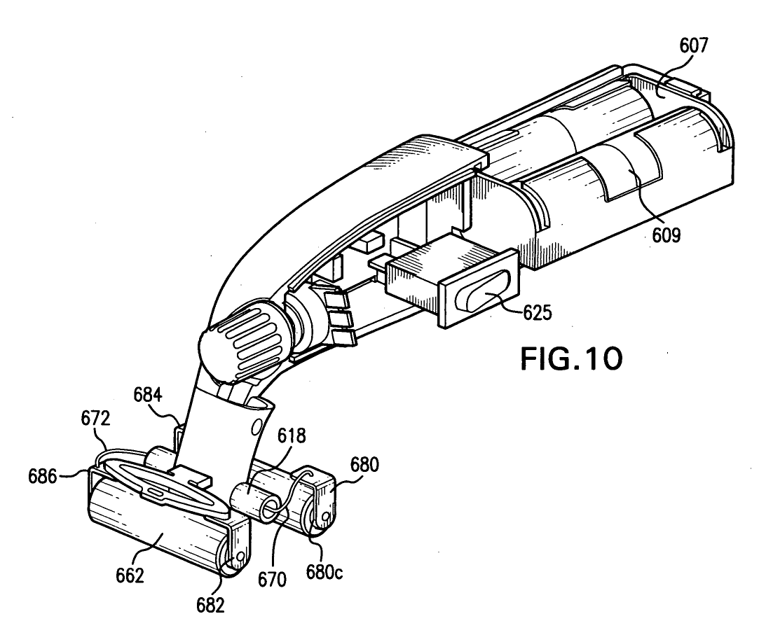

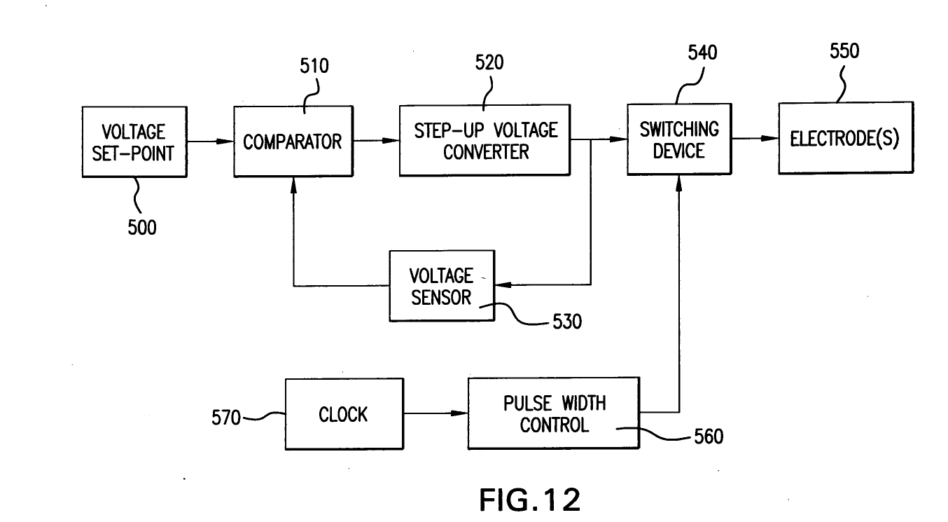

As discussed more fully below in connection with FIG. 12, the electrical circuit is held on a circuit board 629 and is powered by one or more batteries 611, which may be held inside a battery compartment 607 having a battery cover 609. In the preferred embodiment, the wires that carry electricity from the circuit board to the conductive strips pass through the interior of the apparatus forward section 614 and the hollow interior of the transverse cylindrical member 618. From there, as shown in FIG. 10, a wire (e.g., wire 670) is attached to at least one of the two conductive strips (e.g., strip 680) for each roller (e.g., roller 660).

As in the embodiment of FIGS. 1-4, a power switch 625 is used to turn electrical current generation on and off, and a dial 627 allows the electrical current or voltage to be varied. In a preferred embodiment, the electrical current is to provide stimulation to the muscles. However, in alternative embodiments, it may additionally provide power to drive the rollers.

In one embodiment (not shown), each of the rollers 660, 662 may be coupled to the lower casing 650 via an axle that runs axially through the roller and is connected at its ends to the side walls 656, 658 and to one or more of the conductive strips. In embodiments of the invention, the side walls 646, 648 and 656, 658 are long enough to cover a majority of the diameter of the rollers 660, 662. However, in alternative embodiments, the walls 646, 648, 656, 658 may be shorter or longer depending on the overall configuration of the rollers 660, 662, as well as other factors, such as, e.g., ease of use, comfort, and spatial considerations.

In a more preferred embodiment, each of the conductive strips is C-shaped. Thus, referring to strip 680 and associated roller 660 as an example, each conductive strip has: (1) a flat upper horizontal section 680a that slides directly onto, or into a shaped indentation within, the top surface 654 of the lower casing 650 (see FIGS. 8-10); (2) a flat vertical section 680b that slides directly onto, or into a shaped indentation within, the side wall 656 of the lower casing 650; and (3) a tubular lower horizontal section 680c that slides through the side wall 656 and into a matingly-shaped axial cavity of the roller 660. In the preferred embodiment, therefore, each roller has an axial cavity proximate each of its two ends, wherein each of the cavities is of a length and diameter that will accommodate the tubular lower section of one of the conductive strips.

It is noted that only one of the conductive strips is generally needed to deliver electrical current from the electrical circuit to each roller. Thus, in the above-described embodiment, although each roller has a conductive strip coupled to each of its two ends, only one of the strips may deliver electricity to the roller, with the conductive strip on the opposite side serving merely as a connector and (partial) axle for the roller. It is also noted that, in an alternative embodiment, each roller may have a completely hollow interior, where the inner diameter of the roller is dimensioned such that it will accommodate the tubular lower section of one conductive strip at each of its two ends. In either case, the upper casing 640, the lower casing 650, the conductive strips 680, 682, 684, 686, and the rollers 660, 662 may be held together by screws, bolts, or other attachment means 635 (see FIG. 6).

In operation, a user may hold the apparatus 600 by the main body 610 and contact the face, neck, shoulders, or other areas of the body with the rollers 660, 662. In a facial application, for example, the apparatus may be moved up and down, diagonally, sideways, etc. along the counters of the face. As described above, in a preferred embodiment, this is accomplished in part by allowing the applicator 630 containing the rollers 660, 662 to rotate, or swivel, with respect to the main body 610 by means of the transverse cylindrical member 618 rotating within the receptacle 655.

In this regard, the applicator 630 includes a resilient member 690 that is disposed on the top surface 654 of the lower casing 650. More specifically, as shown in FIG. 8, the top surface 654 includes a tab 659 that removably engages the resilient member 690 through an opening proximate the upper edge thereof. On its lower edge, the resilient member 690 includes a contact section 692 that abuts the extension arm 616 (or, more generally, a lower portion of the forward section 614). The resilient member 690 is made of flexible material and generally flexes back and forth in the directions shown by Arrows “A” and “B”. In FIG. 8, the resilient member 690 is shown in its unstressed configuration.

In operation, as the rollers 660, 662 travel on the contact surface (such as, e.g., the subject's face), the applicator 630 may tilt, or rotate (in a clockwise direction) depending on the contours of the contact surface. When the applicator tilts, the force applied to the contact section 692 by the extension arm 616 causes the resilient member to be compressed in the direction of Arrow “A”. Thereafter, the resilient member's tendency is to expand back to its original, unstressed position (in the direction of Arrow “B”). As such, the resilient member 690 generally acts to resist the applicator's rotation such that, depending on the magnitude of the force that is applied to the contact section 692, the applicator 630 will be urged to rotate back to its original, unrotated position. Thus, when the rollers 660, 662 are removed from the contact surface, the applicator 630 will return to its original, unrotated position. It is noted that, in alternative embodiments, the resilient member 690 may be any resilient mechanism, a spring, etc.

FIG. 12 shows a high-level functional schematic of the electronic components of the circuit board 140, 629. These components make it possible to deliver an electrical current strong enough to provide stimulation with small portable batteries. For example, in one embodiment, the electrical circuit is powered by two small “AA” size batteries that deliver 1.5 volts each. The circuit is configured to deliver a sufficiently strong voltage to drive an output current, which, in turn, triggers an action potential in targeted nerve or muscle cells and thereby causes the desired stimulating effect. Small “AA” size batteries are also low in cost, widely available, and can be replaced or recharged with ease.

In one embodiment, the circuit board 140, 629 is comprised of a variety of components. A voltage set point 500 and voltage sensor 530 are provided as input to a comparator 510. In the voltage set point 500, the voltage is set by means of precision resistors (1%) and a variable resistor arranged in a voltage divider configuration. The resistance at the variable resistor is adjusted to change the voltage set-point. In the voltage sensor 530, the output node of a step-up voltage converter 520 is down converted through the voltage divider of the voltage set-point. The center node of this voltage divider is fed into one of the two terminals of a high-input impedance comparator 510. The other terminal of the comparator 510 is fed with an ultra-precise fixed reference voltage. In the comparator 510, a two terminal, fast high-input impedance comparator compares the set-point voltage, by means of the voltage sensor 530, with the ultra-precise fixed reference voltage. If the ultra-precise fixed reference voltage is higher that the voltage at the other terminal of the comparator, then the comparator 510 signals the step-up voltage converter 520 to increase the voltage.

The output of the comparator 510 is fed into a step-up voltage converter 520 which outputs to a switching device 540. The step-up voltage converter 520 is an inductive charge pump that is turned on and off by the comparator 510. When the charge pump is on, the inductive component of the step-up voltage converter 520 is forced to oscillate, thus continuously increasing the voltage at its output node. The switching device 540 is a low-threshold field-effect transistor. The voltage at the gate of the transistor is controlled by a voltage pulse sent by a pulse-width control unit 560. When this pulse is present, the gate of the transistor is polarized, thereby allowing current to flow between the electrode(s) 550 and a reference, which could be an electrode itself.

A clock 570 provides output to the pulse-width control unit 560 that controls the width of the electrical pulses that are delivered to the electrodes 550. The clock 570 is a multivibrator configured as an astable with both frequency and duty cycle fixed, though in other embodiments the frequency and duty cycle can be variable. The pulse-width control unit 560 is a multivibrator configured as a monostable with a fixed-pulse or variable-pulse duration. This monostable configuration is triggered by the clock 570. The pulse-width control unit drives the voltage at the gate of the transistor in the switching device. The switching device 540 is switched on by the output of the pulse width control unit 560; this allows electrical current, generated by means of the output voltage from the step-up voltage converter 520, to be delivered through the electrode(s) 550. The electrode(s) (e.g., the rollers 660, 662) constitute the contact point with the body.

In embodiments of the invention, the electrical circuit may deliver square pulses, or other wave form, at frequencies below 100 Hz. In alternative embodiments, the electrical circuit may deliver square pulses, or other wave form, at frequencies at, or above 100 Hz. In some preferred embodiments of the invention, the electrical circuit may deliver square pulses at frequencies between 50 and 80 Hz. In one specific embodiment, the pulse frequency may be about 60 Hz. In yet another specific embodiment, the pulse frequency may be about 75 Hz. In one embodiment of the invention, the clock 570 and the pulse width control unit 560 may be implemented by means of a microprocessor or microcontroller (not shown), which allows for greater flexibility in setting the frequency and the pulse width of the electrical stimulation.

The voltage is in the range of 14-148 volts, plus or minus 14 volts, with voltage control provided. Current in the voltage control circuit will automatically adjust depending on the impedance or resistance along the current path at any given time. In other embodiments, providing current control will be more desirable because current drives the stimulation effect. In either form of control, current or voltage will not exceed a certain preset level due to protective measures built into the circuitry.

To facilitate the flow of electrical current, the apparatus may be used with a conductive gel applied to the skin in the areas of treatment. The conductive gel may be water soluble and may have firming and tightening agents that improve the appearance of the skin. The gel may be wiped off the skin following the use of the device. The gel can be used as part of the treatment to augment the results obtained from the device.

In addition, the apparatus 600 may be used as an iontophoresis device to deliver various ingredients and/or treatments to the subject's skin, tissue, and/or muscles. The treatment may, for example, be an ingredient from over-the-counter formulas for the treatment of acne, psoriasis, and other topical dermatologic conditions. It may also generally be a medication, including a topical ointment, pain reliever, muscle relaxant, etc.

In an additional embodiment of the present invention (not depicted), the electrodes may vibrate to provide further stimulation to the skin and underlying tissues. Vibration may be provided by means of pads or other non-rolling electrodes. The electrodes may be contained on a single vibrating pad, or may be contained on separate pads. If contained on a single pad, the electrical current flows from an electrode on the pad through the skin to another electrode on the same pad. If electrodes are contained on separate pads, the electrical current flows from an electrode on one pad through the skin to a separate electrode on a separate pad.

The electrodes may comprise all or a portion of the contact surface of the vibrating pad. A vibrating pad must be of sufficient surface area to have the desired effect. An electrode can typically deliver a current with a relatively smaller surface area than that required to have the desired effect. Thus, the electrode may comprise a smaller surface area than the contact surface of the vibrating pad.

Alternately to providing vibration by means of a pad, vibration may be provided by rolling electrodes substantially as described above. In this instance, an additional vibrating mechanism is provided to vibrate the wheels, as is well known in the art. The addition of vibration to the present invention provides, in addition to electrical stimulation and massage, another means of stimulating the skin and underlying muscles in accordance with the various aspects and applications of the invention as described herein. Furthermore, by means of the gate-control theory of pain, vibration can also provide a local numbing effect, which translates into a higher level of tolerance for the electrical stimulation.

Without departing from the spirit and scope of this invention, one of ordinary skill in the art can make various changes and modifications to the present invention to adapt it to various uses and conditions. As such, these changes and modifications properly fall within the scope of the invention.

For example, although, in the above discussion in connection with the embodiments of FIGS. 5-11, reference has been made to two rollers, such reference is by way of illustration only, and not by way of limitation, and embodiments of the invention may include one or more rollers of the type described. In addition, where more than one roller is included, one or more of the rollers may be in electrical communication with the electrical circuit so as to provide electrical stimulation to the subject.

Also, in alternative embodiments, the components of the apparatus 600 that have been described as being integrated, or unitary with one or more other components may be instead detachably connectable to those other components. Similarly, components that have been described as being separate and/or detachable may be made as a single unitary or integrated structure. Thus, for example, although the main body 610 and the extension arm 616 have been described as two separate structures that are coupled to one another, in alternative embodiments of the invention, the main body and extension arm may be a single, integrated unit. In such an embodiment, the transverse cylindrical member 618 may be detachable from the extension arm 616. In this way, during assembly, the extension arm 616 would first be moved through the opening 642 of the upper casing 640, followed by connection of the transverse cylindrical member 618 to the extension arm 616.

With specific regard to the transverse cylindrical member 618, it will be clear from the above discussion that, in the preferred embodiment, this component serves various functions, including those of allowing the applicator 630 to rotate with respect to the main body 610 and serving as a conduit for the wires 670, 672. However, in alternative embodiments, where the applicator 630 is stationary (i.e., where it does not swivel), the transverse cylindrical member 618 may take on various other shapes having a non-circular cross-section. In addition, the wires 670, 672 may be routed to the roller(s) 660, 662 differently, such that they do not run through the hollow interior of the transverse cylindrical member 618. In this case, the member 618 may be a solid, flat structure, or it may be eliminated altogether. Thus, in an embodiment, for example, where the applicator 630 does not rotate, the upper casing 640 may be unitary with the main body 610/extension arm 616, with the cylindrical member eliminated and the wires 670, 672 extending through the end 617 (and/or the sides) of the extension arm 616.

Many additional alternatives, modifications, and variations will be apparent to those skilled in the art and in light of the description herein. Accordingly, it is intended that the appended claims cover any and all such alternatives, modifications, and variations that fall within the spirit thereof, as well as all of the embodiments disclosed and suggested herein and any equivalents thereof.

What is claimed is:

1. A muscle stimulation apparatus comprising:
a body portion;
a head portion coupled to said body portion and having a roller connected thereto; and
an electrical circuit housed within the body portion and configured to selectively deliver electrical current to the roller;
wherein the roller is configured to rotate upon a user's skin so as to deliver said electrical current to muscles underlying the user's skin.

2. The apparatus of claim 1, wherein said body portion has a forward section and a rear section, said head portion being coupled to said forward section.

3. The apparatus of claim 2, wherein the body portion tapers from the rear section to the forward section.

4. The apparatus of claim 2, wherein said forward section is angled with respect to said rear section.

5. The apparatus of claim 2, wherein said forward section includes a transverse cylindrical member, and said head portion includes a receptacle configured to matingly receive said cylindrical member.

6. The apparatus of claim 5, further including a conductive strip in electrical communication with said roller, wherein the cylindrical member is hollow and is configured to receive therethrough a wire that delivers the electrical current from the electrical circuit to the conductive strip.

7. The apparatus of claim 5, wherein the head portion is configured to rotate with respect to the body portion.

8. The apparatus of claim 7, further including a resilient member for resisting the head portion's rotation.

9. The apparatus of claim 8, wherein said resilient member is a spring.

10. The apparatus of claim 1, wherein the electrical circuit is battery-powered, said body portion further including a battery compartment.

11. The apparatus of claim 1, wherein said electrical circuit delivers monophasic current.

12. The apparatus of claim 1, wherein said electrical circuit delivers biphasic current.

13. The apparatus of claim 1, further including means for selecting the magnitude of the electrical current to be delivered to the user's muscles.

14. The apparatus of claim 13, wherein said magnitude is selectable from a continuous range of magnitudes.

15. The apparatus of claim 1, wherein the roller is configured to massage the user's muscles as it rotates on the user's skin.

16. The apparatus of claim 15, wherein the roller includes a plurality of massaging protrusions around the periphery thereof.

17. The apparatus of claim 1, said roller being configured for application to at least one of the user's face, neck, and shoulders.

18. The apparatus of claim 1, further including a plurality of rollers.

19. The apparatus of claim 18, further including a plurality of conductive strips, each said roller being in electrical communication with at least one of said conductive strips for receiving said current from the electrical circuit.

20. The apparatus of claim 1, wherein said roller is further configured to deliver a treatment to the user.

21. The apparatus of claim 20, wherein said treatment is at least one member selected from the group consisting of a skin creme, a medication, a gel, and an acne treatment.

22. A muscle stimulation apparatus comprising:
a main body having an angled forward section;
an applicator rotatably coupled to the main body's forward section;
an elongated roller contained at least partially within said applicator;
an electrical circuit housed within the main body and configured to generate an electrical current for delivery to the roller; and
means for setting the magnitude of the electrical current, wherein the roller is configured to rotate upon a user's face, neck, or shoulders, thereby delivering the electrical current to the muscles of user's face, neck, or shoulders.

23. The apparatus of claim 22, wherein the main body's forward section includes a detachable extension arm having a free end, said applicator being rotatably coupled to the extension arm proximate said free end.

24. The apparatus of claim 23, further including:
a hollow cylindrical member disposed transversely proximate said free end of the extension arm, said applicator being configured to rotate about an axis defined by the longitudinal axis of said cylindrical member;
a conductive strip in electrical communication with said roller;
means for delivering the electrical current to the conductive strip; and
means for resisting rotation of the applicator such that, when the apparatus is not in use, the applicator returns to its original, unrotated position.

25. The apparatus of claim 24, wherein the applicator includes a plurality of rollers, each said roller receiving the generated electrical current and delivering it to said user's muscles.

26. The apparatus of claim 24, wherein said means for delivering the electrical current is a wire or cable, and said means for resisting rotation of the applicator is a spring.

27. The apparatus of claim 22, wherein the applicator is adapted to rotate in accordance with the contours of the user's face, neck, or shoulders.

28. The apparatus of claim 22, wherein said roller is further configured to deliver a medication or treatment to the user's face, neck, or shoulders.

29. The apparatus of claim 28, wherein said medication or treatment is at least one member selected from the group consisting of a skin creme, an acne treatment, a topical ointment, a gel, and a muscle relaxant.

30. A skin and muscle treatment apparatus comprising:
a main body having a tapered handle portion and an angled forward section;
an applicator rotatably coupled to the main body's forward section;
a conductive roller contained at least partially within said applicator;
a conductive strip in electrical communication with said roller;
an electrical circuit housed within the main body and configured to generate an electrical current for delivery to the roller through the conductive strip; and
means for selecting the magnitude of the electrical current delivered, wherein the roller is configured to deliver said electrical current and a treatment to a user as it rotates upon the user's skin.

31. The apparatus of claim 30, wherein said treatment is a medication.

32. The apparatus of claim 30, wherein said treatment is at least one member selected from the group consisting of a skin creme, an acne treatment, a topical ointment, a gel, and a muscle relaxant.

33. The apparatus of claim 30, wherein the applicator includes a plurality of conductive rollers and a plurality of conductive strips in electrical communication therewith, at least one of said rollers receiving the electrical current through at least one of said conductive strips.

34. The apparatus of claim 30, wherein said roller is configured for application to at least one of the user's face, neck, and shoulders.

35. The apparatus of claim 30, wherein the roller is configured to massage the user's muscles as it rotates on the user's skin.
